(19) United States
(12) Patent Application Publication
(10) Pub. No.: US 2002/0026858 A1
(43) Pub. Date: Mar. 7, 2002

(54) Switching arrangement for a reversible ratchet type wrench

(76) Inventor: Bobby Hu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/900,997

(22) Filed: Jul. 9, 2001

(30) Foreign Application Priority Data
Sep. 1, 2000 (TW) 89215264

(51) Int. Cl. B25B 13/46

(52) U.S. Cl. 81/63.1

(57) ABSTRACT

A wrench includes a handle and a head extended from the handle. The handle comprises a transverse receptacle communicated with a hole in the head and a cavity that communicates with the transverse receptacle. Two pawls are mounted in the transverse receptacle and each include a first side for releasably engaging with a drive member in the hole of the head and a second side abutting against an inner longitudinal wall of the transverse receptacle. A switch member is rotatably mounted in the cavity of the handle and comprises an actuating portion for selectively moving one of the pawls to a position not engaging with the drive member. The switch member further comprises two support portions for selectively supporting a portion of the other pawl that disengages from the inner longitudinal wall of the transverse receptacle, thereby supporting the other pawl that engages with the drive member.

### BACKGROUND OF THE INVENTION

1. Field of the Invention

The present invention relates to a switching arrangement for a reversible ratchet-type wrench to provide reliable ratcheting and to allow easy assembly and manufacture.

2. Description of the Related Art

Several factors are considered in designing wrenches and spanners, including improving the torque-bearing capacity, providing as many teeth as possible for the drive member, and providing an easy-to-manufacture structure. U.S. Pat. No. 2,957,377 issued to Hare on Oct. 25, 1960 discloses a reversible ratchet type wrench comprising a body 10 having a handle 11 and a head 12. A cap 39 and an annular wall 44 are provided to upper side and lower side of the head 12, respectively. Yet, this increases the assembly time and the manufacture cost and adversely affects the appearance. A shifting lever 35 is retained in place by a spring 33 that is located in a cylindrical opening 34. Nevertheless, formation of the cylindrical opening 34 that extends upward at an incline is relatively difficult. In addition, formation of the cavity 16 having converging straight sides 17, 18 which diverge in the direction of the periphery of rotatable member 14 requires expensive and accurate computer-numeric-control (CNC), which further results in an increase in the cost together with a low production rate. This is why such a reversible ratchet type wrench is hardly seen in the market.

FIGS. 13 and 14 illustrate another conventional ratchet type wrench comprising a handle 12′ and a head 11′. The head 11′ is machined to form four consecutive compartments for receiving the drive member 20′, the pawl 30′ and the shifting lever 40′, wherein three of the compartments can be formed by cutting, yet the remaining one must be machined by CNC. Further, the resultant head structure is relatively weak and thus has a poor torque-bearing capacity. In addition, the movement of the pawl 30′ for changing ratcheting direction is found unreliable, as it is achieved via transmission of the hook end 442′ of a spring 44′ attached to the shifting lever 40′.

FIG. 15 of the drawings illustrates a conventional wrench of the type having a handle B′ and a head in which a drive member A′ is rotatably received. A pawl D′ is slidably received in a transverse through-hole C′ in a web between the handle B′ and the head. However, an end of the pawl D′ extends beyond the transverse through-hole C′ and thus adversely affects operation of the wrench when used in a limited space. A two-pawl type wrench was proposed to solve this problem. As illustrated in FIGS. 16 through 18, the two-pawl type wrench includes a handle 1′ and a head 11′ extended from the handle 1′. A drive member 2′ is rotatably received in the head 11′, a receptacle 12′ is defined in a web between the handle 1′ and the head 11′, and a spring-biased switch member 4′ is mounted in a cavity 13′ in the web. Two spaced pawls 3′ are received in the receptacle 12′ and are biased by two springs 6′, respectively. A threaded end cap 5′ is engaged with a threaded outer end 121′ of the receptacle 12′ to enclose the pawls 3′ and springs 6′. As illustrated in FIGS. 17 and 18, the switch member 4′ is turned to bias one of the pawls 3′ to engage with the drive member 2′ to thereby change the ratcheting direction of the wrench. However, it was found that the switch member 4′ cannot be reliably retained in place and thus tend to disengage from the cavity 13′. In addition, the pawl 3′ engaged with the drive member 2′ is not engaged with an inner longitudinal wall that defines the transverse through-hole and that faces the drive member 2′. As a result, the torque-bearing capacity of the wrench is poor. Furthermore, the outer pawl 3′ (FIGS. 17 and 18) tends to be stuck when the threaded end cap 5′ is mounted too close to the switch member 4′. To the contrary, if the threaded end cap 5′ is too far away from the switch member 4′, the pawl 3′ cannot be firmly engaged with the drive member 2′. Further, the threaded end cap 5′ tends to be disengaged from the drive member 2′, as the former is in threading engagement with the threaded outer end 121′ of the receptacle 12′.

FIGS. 19 through 21 illustrate another conventional wrench having a substantially V-shape transverse through-hole 25′ in a web between a handle 20′ and a head 21′ thereof. The head 21′ includes a compartment in which a drive member 22′ is rotatably received. A spring-biased pawl 23′ is received in each limb of the V-shape transverse through-hole 26′. A switch member 30′ includes a stem 35′ pivotally received in a cavity 24′ in the web and a thumb-piece 30′ extending from the stem 35′ for manual operation, thereby switching the switch member 30′ between two positions corresponding to two opposite ratcheting direction of the wrench. The thumb piece 32′ of the switch member 30′ includes a downwardly facing receptacle 36′ (FIG. 21) for receiving a spring 37′ and a ball 38′ that is biased by the spring 37′ to be positioned in one of two positioning recesses 281′ (FIG. 20) in a sector-like recessed area 28′ (FIG. 19) of the web. The switch member 30′ may be retained in place reliably. However, a C-clip 33′ is required for mounting the switch member 30′ in place, which adversely affects the aesthetically pleasing effect. In addition, processing of the sector-like recessed area 28′ in the web and the V-shape transverse through-hole 25′ is difficult. Mounting of the switch member 30′ as well as the pawl 23′ and associated springs 26′ and threaded end caps 27′ are troublesome and time-consuming. The sector-like recessed area 28′ in the web results in an increase in the overall thickness of the wrench, which limits application of the wrench in limited spaces. The torque-bearing capacity was found poor, as only a portion of the pawl 23′ meshed with the drive member 22′ was supported by the inner wall of the V-shape transverse through-hole 25′, as shown in FIG. 20.

### SUMMARY OF THE INVENTION

In accordance with the present invention, a reversible ratchet type wrench comprises:

a handle;

a head extended from the handle and including a hole, the handle comprising a transverse receptacle communicated with the hole, the transverse receptacle comprising an inner longitudinal wall that faces the hole of the head, the handle further comprising a cavity that communicates with the transverse receptacle;

a drive member rotatably mounted in the hole of the head, the drive member including a plurality of teeth formed on an outer periphery thereof;

two pawls mounted in the transverse receptacle in a spaced manner and each including a first side with a plurality of teeth for releasably engaging with the teeth of the drive member and a second side abutting against the inner longitudinal wall of the transverse receptacle;

a switch member including a turn-piece for manual operation, the switch member being rotatably mounted in the cavity of the handle and comprising an actuating portion for selectively moving one of the pawls to a position not engaging with the teeth of the drive member, the switch member further comprising two support portions for selectively supporting a portion of the other pawl that disengages from the inner longitudinal wall of the transverse receptacle, thereby supporting the other pawl that engages with the teeth of the drive member; and

means for biasing the teeth of the pawls to engage with the teeth of the drive member, respectively.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an end portion of a first embodiment of a wrench in accordance with the present invention.

FIG. 2 is an exploded perspective view of the wrench in FIG. 1.

FIG. 3 is a sectional view of the wrench in FIG. 1.

FIG. 4 is a sectional view taken along line 4-4 in FIG. 3, wherein the wrench is in a status allowing clockwise ratcheting.

FIG. 5 is a view similar to FIG. 4, wherein the wrench is in a status allowing counterclockwise ratcheting.

FIG. 6 is a sectional view illustrating a modified embodiment of the gear wheel of the wrench in FIG. 1.

FIG. 7 is an exploded perspective view of another modified embodiment of the wrench in accordance with the present invention.

FIG. 8 is a sectional view, taken along line 8-8 in FIG. 10, of the wrench in FIG. 7, wherein the wrench is in a status allowing clockwise ratcheting.

FIG. 9 is a view similar to FIG. 8, wherein the wrench is in a status allowing counterclockwise ratcheting.

FIG. 10 is a sectional view of the wrench in FIG. 7.

FIG. 11 is an exploded perspective view of a further modified embodiment of the wrench in accordance with the present invention.

FIG. 12 is an exploded perspective view of still another modified embodiment of the wrench in accordance with the present invention.

FIG. 13 is an exploded perspective view of a conventional ratchet type wrench.

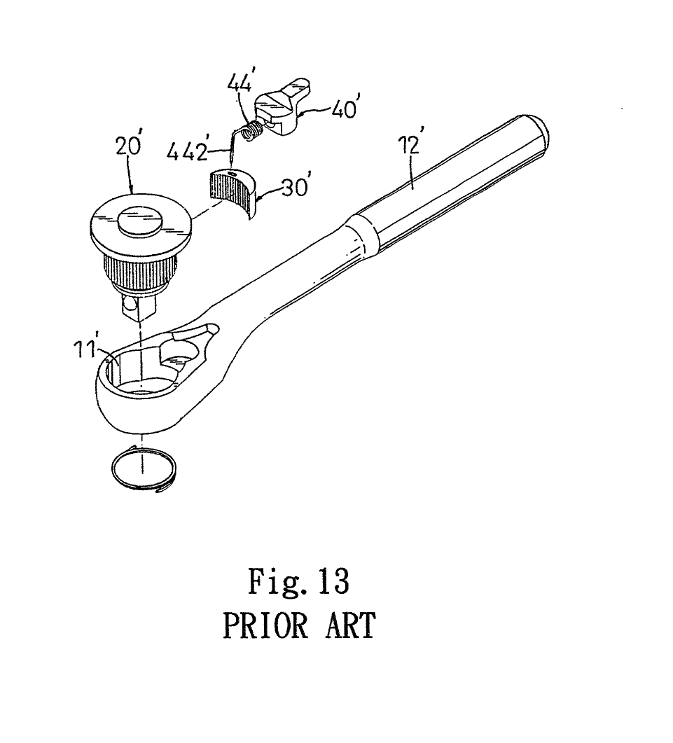

FIG. 14 is a sectional view of a head portion of the conventional ratchet type wrench in FIG. 13.

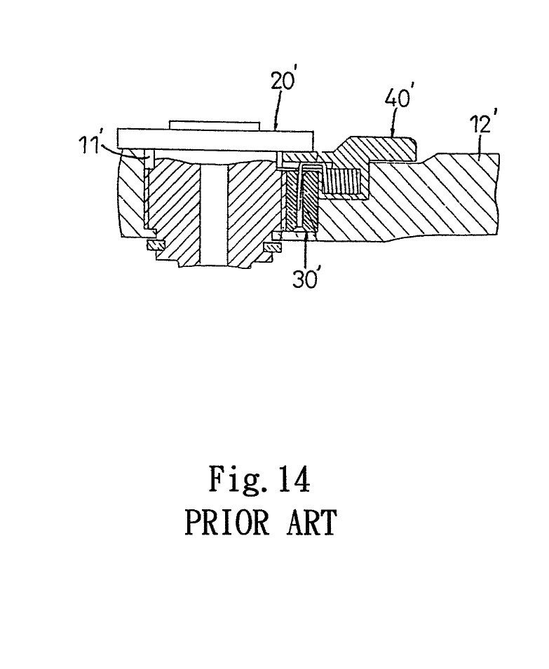

FIG. 15 is a top view, partly sectioned, of a portion of a conventional wrench.

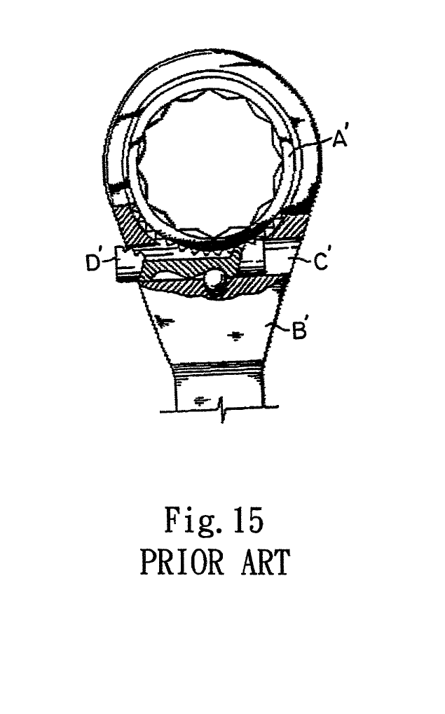

FIG. 16 is an exploded view of a portion of another conventional wrench.

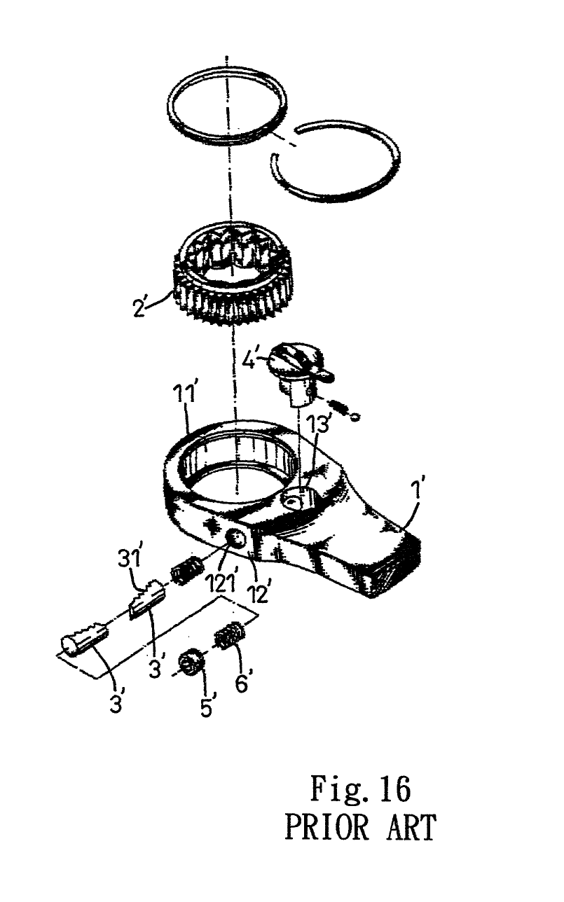

FIG. 17 is a top view, partly sectioned, of the portion of the conventional wrench in FIG. 16.

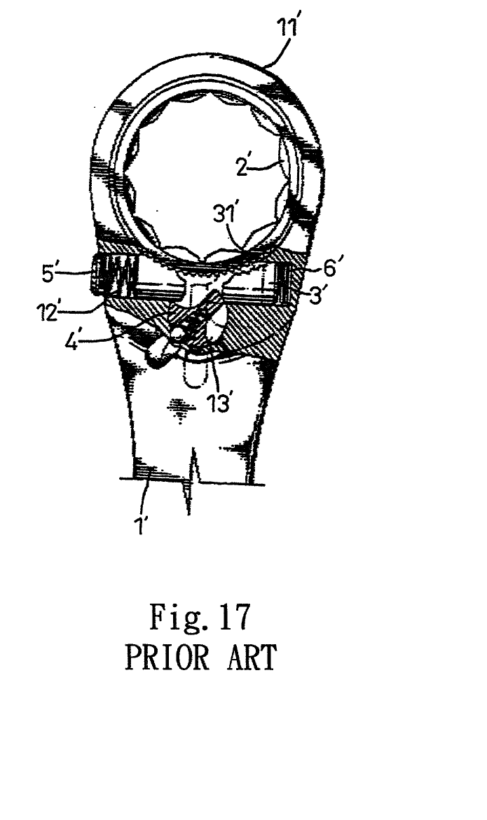

FIG. 18 is a view similar to FIG. 17, wherein the switch member of the wrench is in a position for ratcheting in a reverse direction.

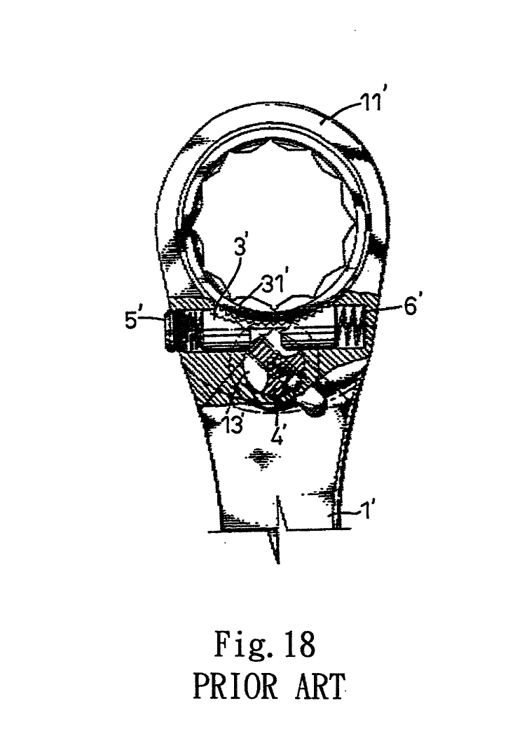

FIG. 19 is an exploded perspective view of a further conventional wrench.

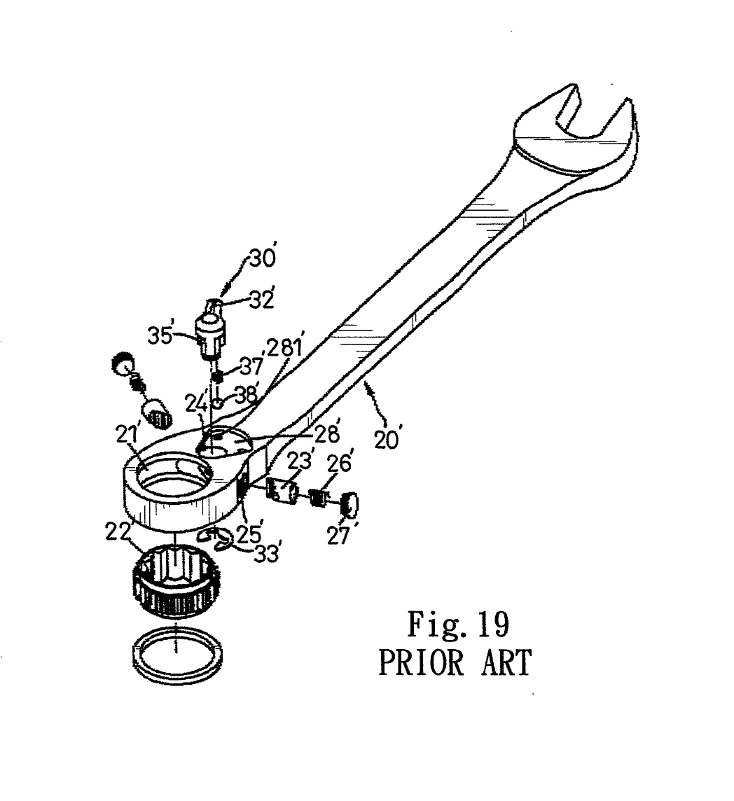

FIG. 20 is a top view, partly sectioned, of a portion of the conventional wrench in FIG. 19.

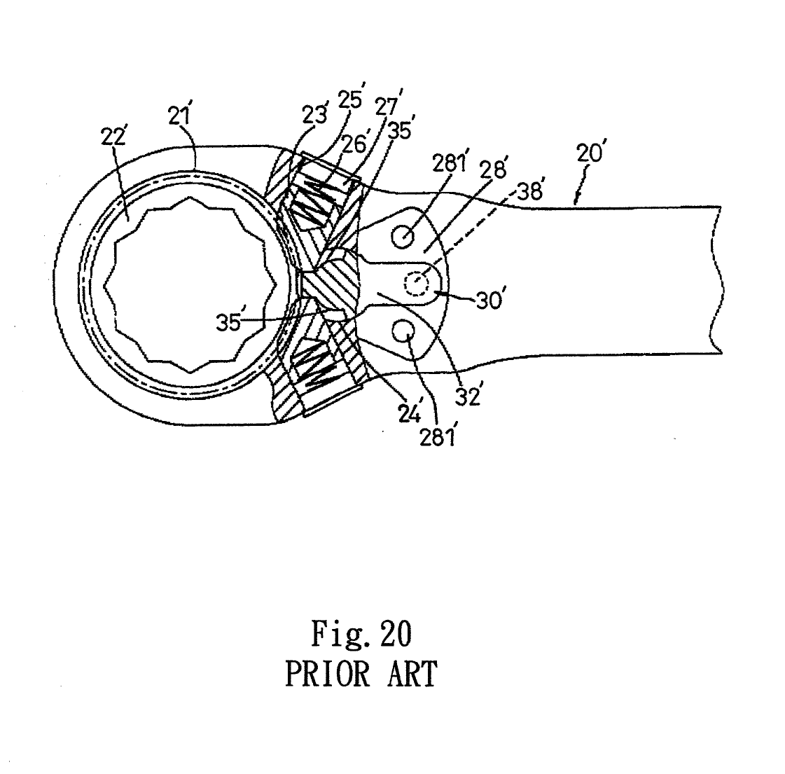

FIG. 21 is a side view, partly sectioned, of the portion of the conventional wrench in FIG. 19.

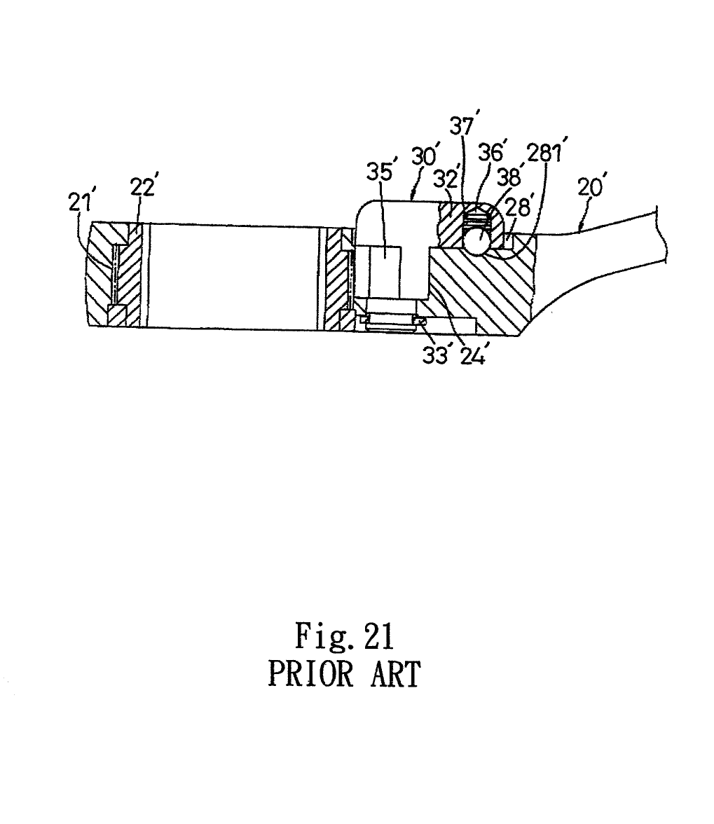

### DETAILED DESCRIPTION OF THE PREFERRED EMBODIMENTS

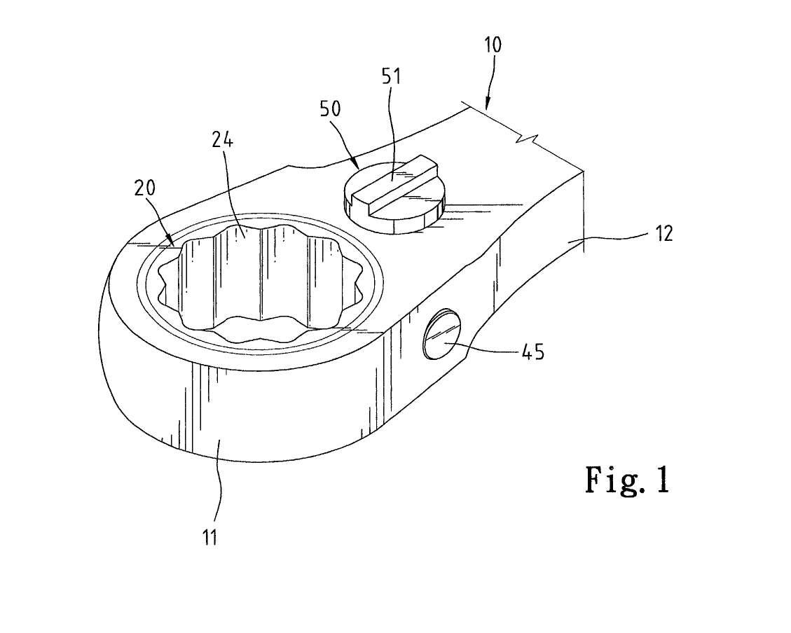

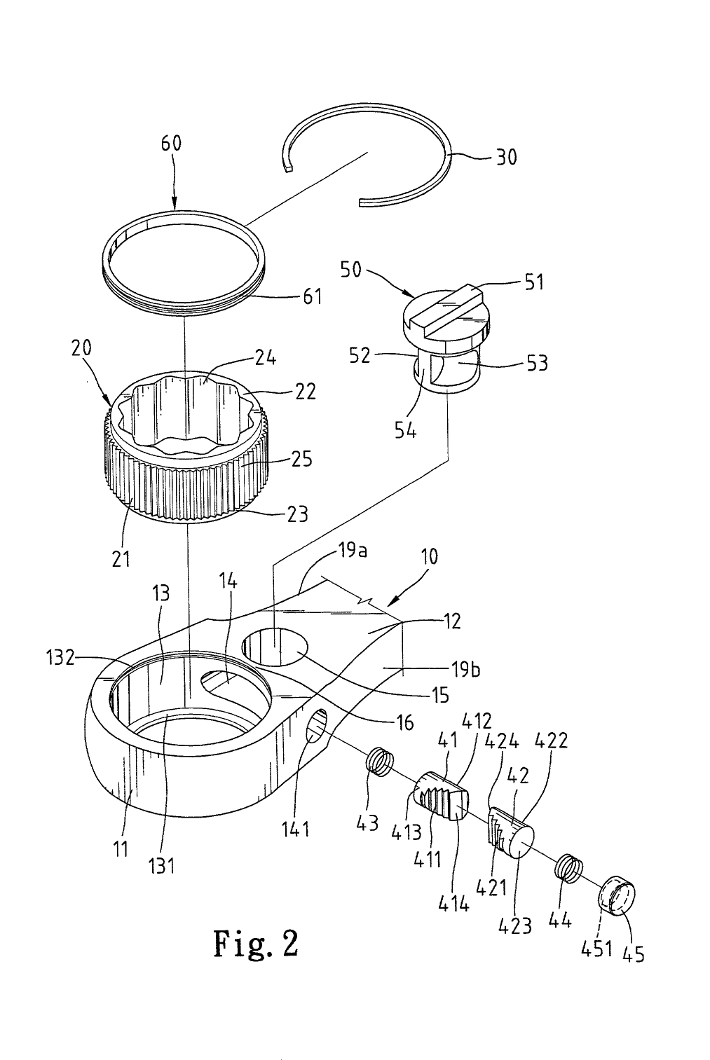

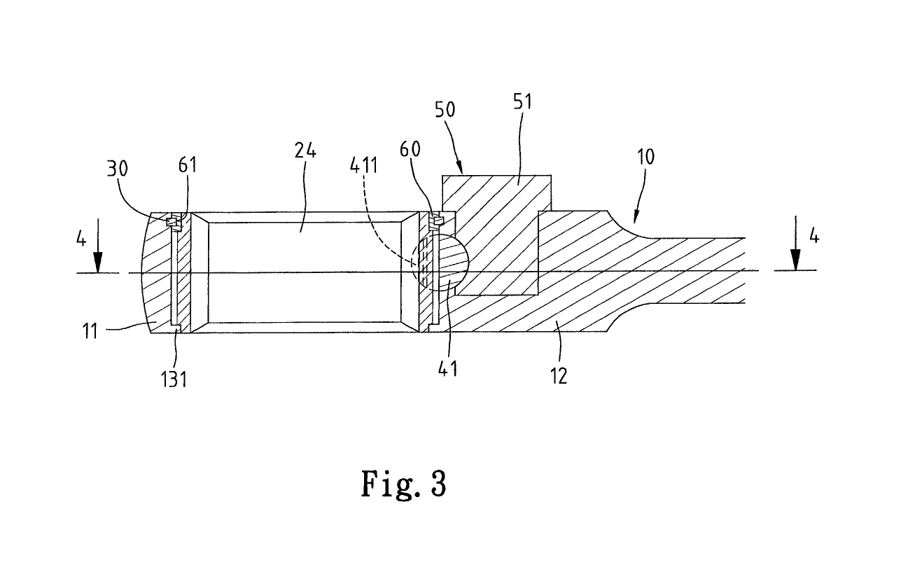

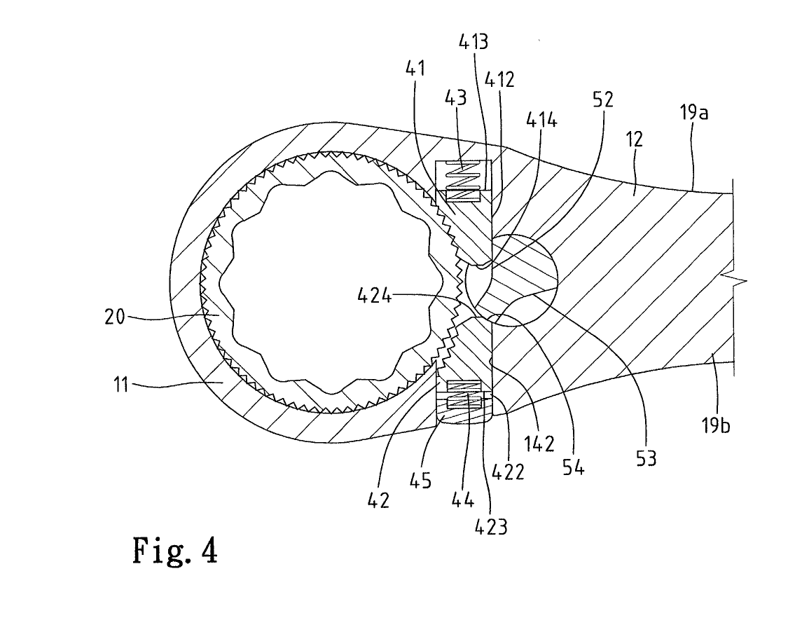

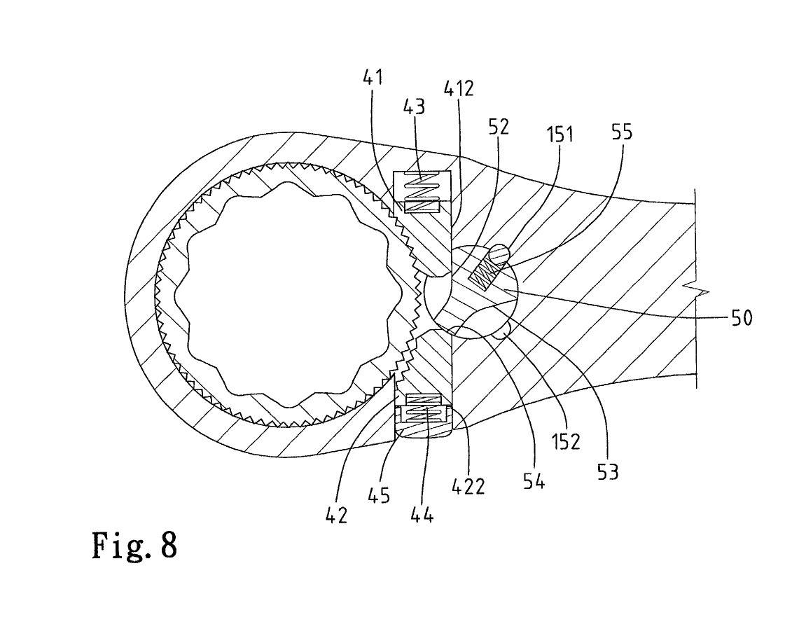

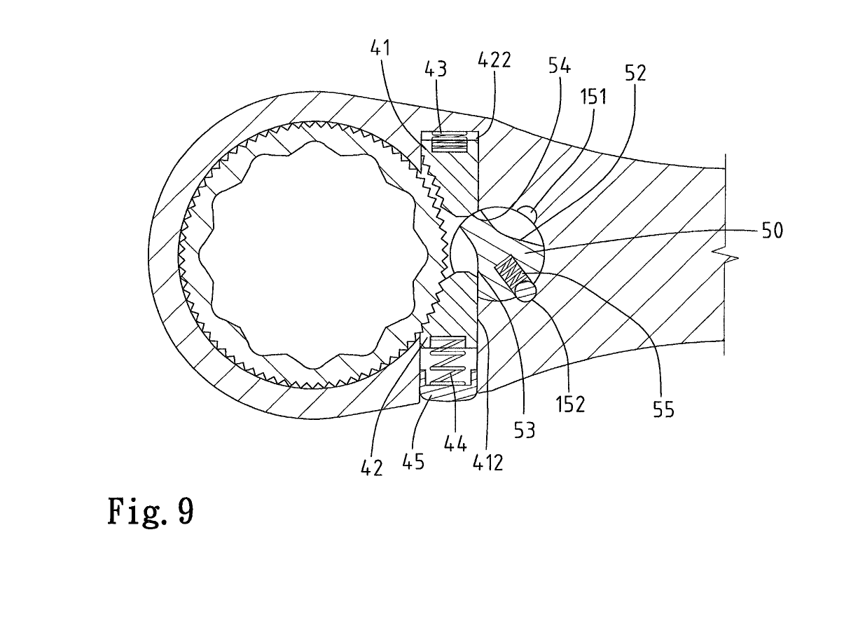

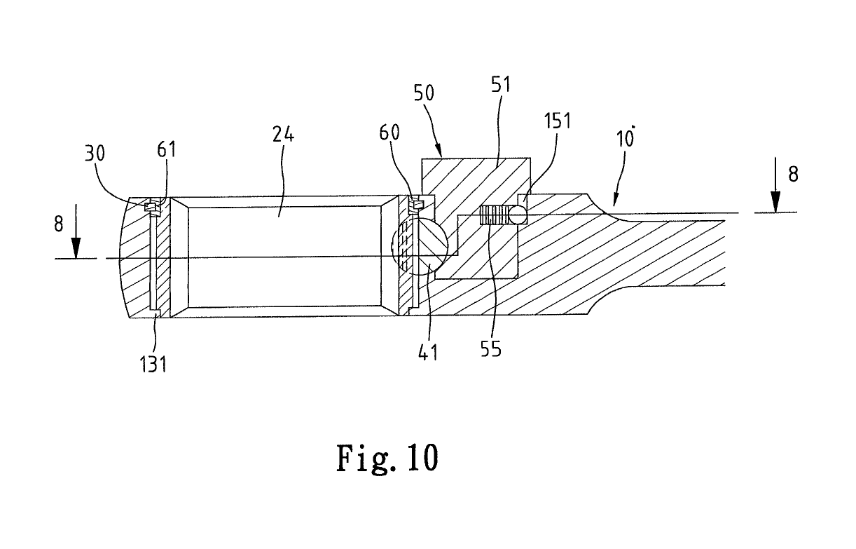

Referring to FIGS. 1 through 12 and initially to FIGS. 1 through 4, a ratchet type wrench 10 in accordance with the present invention generally includes a handle 12 and a head 11 having a hole 13. An inner periphery defining the hole 13 of the head 11 includes an annular groove 132 in an upper portion thereof and an annular ledge 131 on a lower portion thereof. A transverse receptacle 14 (FIG. 4) is defined in the handle 12 and includes an intermediate portion communicated with the hole 13. The transverse receptacle 14 extends from one lateral side 19b of the handle 12 toward the other lateral side 19a of the handle 12 but spaced from the other lateral side 19a, thereby defining an opening 141 in the lateral side 19b. The transverse receptacle 14 includes an inner longitudinal wall 142 (FIG. 4) that faces the hole 13, which will be described later. A cavity 15 is defined in the handle 12 and communicated with the transverse receptacle 14. The cavity 15 communicated with the transverse receptacle 14 has a first end communicated with outside and a second end located in the handle 12, thereby leaving a bridge 16 on the handle 12 for connecting with the head 12. Namely, the cavity 15 extends from an upper side of the handle 12 toward a bottom side of the handle 12 but spaced from the bottom side of the handle 12, best shown in FIG. 3. The cavity 15 is preferably cylindrical. The bridge 16 increases the strength of the head 11 and the handle 12, thereby providing a higher torque-bearing capacity.

A drive member (in the form of a gear wheel 20 in this embodiment) is mounted in the head 11 and includes an inner periphery 24 for driving a fastener (not shown) and an outer periphery 25. The outer periphery 25 includes a recessed upper end portion 22, a recessed lower end portion 23, and a middle portion with a plurality of recessed teeth 21. A retainer 60, preferably a ring, is mounted around the recessed upper end portion 22 and includes an annular groove 61. A C-clip 30 is engaged in the annular groove 61 of the retainer 60 and in the annular groove 132 of the head 13, thereby rotatably retaining the gear wheel 20 in the head 11 of the wrench 10, best shown in FIG. 3. As illustrated in FIG. 3, the recessed lower end portion 23 abuts against and is thus supported by the annular ledge 131 of the head 11.

Two pawls 41 and 42 are mounted in cavity 14 in a spaced manner and each include ratchet teeth 411, 421 on a side thereof for engaging with teeth 21 of the gear wheel 20. The ratchet teeth 411, 421 are preferably arranged along a concave face so as to be in intimate contact with the teeth 21 of the gear wheel 20. The other side 412, 422 of each pawl 41, 42 presses against the inner longitudinal wall 142, best shown in FIG. 4. The inner pawl 41 further includes an end 413 to which an end of an elastic element (e.g., a spring 43) is attached, the other end of the spring 43 being attached to an end wall defining the transverse receptacle 141. The outer pawl 42 includes an outer end 423 to which an elastic element (e.g., a spring 44) is attached. An end cap 45 is securely mounted in the opening 141 of the transverse receptacle 14, and the other end of the spring 44 is attached to an inner side of the respective end cap 45. Thus, the respective pawl 41, 42 is biased by the respective spring 43, 44 toward the gear wheel 20.

Still referring to FIGS. 1 through 3, a switch member 50 is rotatably mounted in the cavity 15. In this embodiment, the switch member 50 includes a turn-piece 51 on a top thereof, the turn-piece 51 being preferably located outside the cavity 15 for manual operation. The switch member 50 comprises an actuating portion 54 for selective engagement with an end 414, 424 of the respective pawl 41, 42. The switch member 50 further comprises two support portions 52 and 53 each for supporting a portion of the second side 411, 421 of the respective pawl 41, 42, best shown in FIG. 4. It is noted that the switch member 50 includes a bottom 56 that is located below the pawls 41 and 42 after assembly, thereby preventing disengagement of the switch member 50.

The ratchet type wrench in FIG. 4 is in a status allowing clockwise ratcheting (free rotation in counterclockwise direction), in which the actuating portion 54 of the switch member 50 presses against the end 424 of the pawl 42, thereby disengaging the pawl 42 from the gear wheel 20. The other pawl 41 is biased by the spring 43 toward the gear wheel 20. The teeth 411 of the pawl 41 are in intimate contact with the gear wheel 20 and the leading portion (not labeled) of the second side 412 of the pawl 41 that leaves the inner longitudinal wall 142 of the transverse receptacle 14 is supported by the support portion 52 of the switch member 50. A higher torque is provided, as the drive member 20 is firmly engaged with and in intimate contact with the teeth 411 of the pawl 41. In addition, the force transmitted to the pawl 41 from the drive member 20 is distributed to the inner longitudinal wall 142 of the transverse receptacle 14 having a relatively large area. As a result, the wrench in accordance with the present invention may bear higher torque.

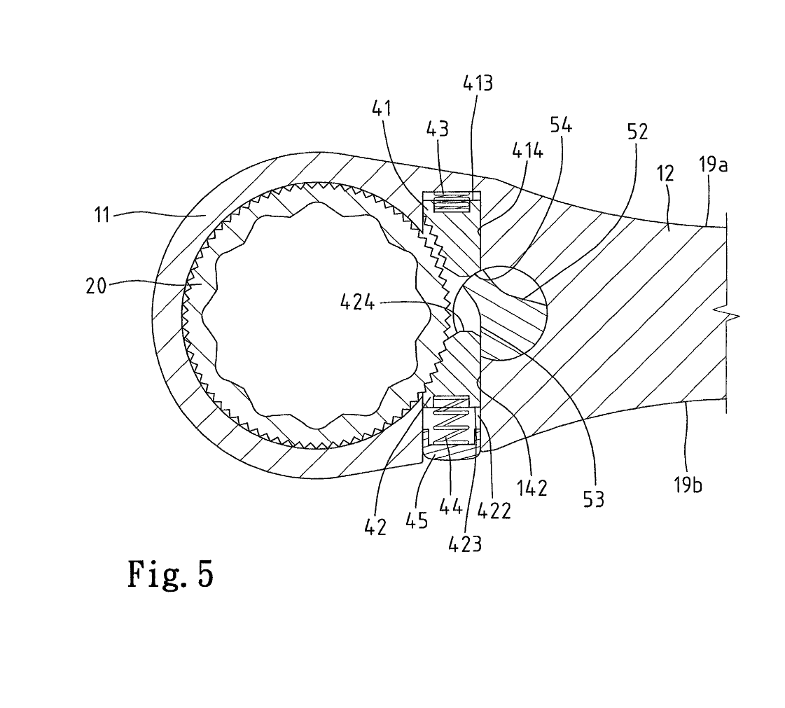

When a change in the ratcheting direction is required, the user may switch the turn-piece 51 and thus move the actuating portion 54 of the switch member 50 to press against the pawl 41. Thus, the ratchet-type wrench is in a status allowing counterclockwise ratcheting and free rotation in the clockwise direction. As illustrated in FIG. 5, the actuating portion 54 of the switch member 50 presses against the end 414 of the pawl 41, thereby disengaging the pawl 41 from the gear wheel 20. The pawl 42 is biased by the spring 44 toward the gear wheel 20. The teeth 421 of the pawl 42 are in intimate contact with the gear wheel 20 and the leading portion (not labeled) of the second side 422 of the pawl 42 that leaves the inner longitudinal wall 142 of the transverse receptacle 14 is supported by the support portion 53 of the switch member 50. A higher torque is provided, as the drive member 20 is firmly engaged with and in intimate contact with the teeth 421 of the pawl 42. In addition, the force transmitted to the pawl 42 from the drive member 20 is distributed to the inner longitudinal wall 142 of the transverse receptacle 14 having a relatively large area. As a result, the wrench in accordance with the present invention may bear higher torque.

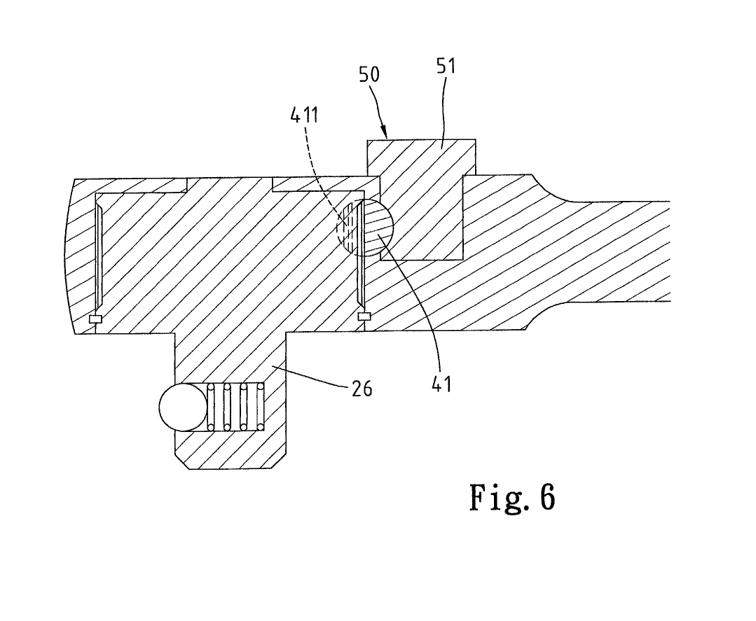

FIG. 6 is a modified embodiment of the wrench in accordance with the present invention, wherein the gear wheel 20 in the above embodiment is replaced by a drive member of the type having a drive column 26.

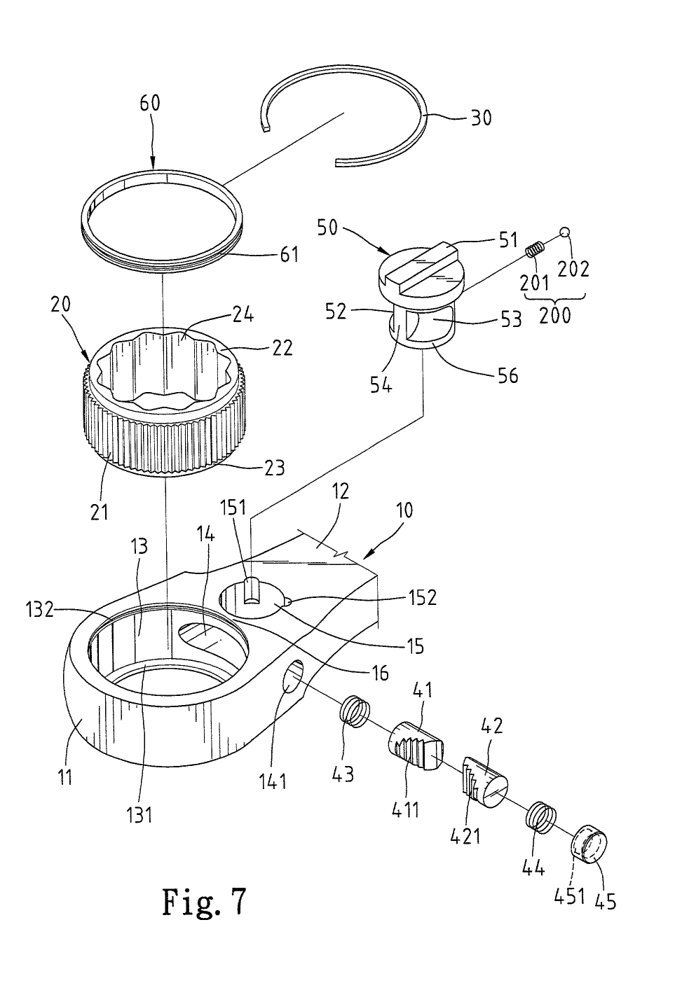

FIGS. 7 through 10 illustrates another modified embodiment in accordance with the present invention, wherein the cavity 15 includes a first positioning recess 151 and a second positioning recess 152 that can be processed from the upper side of the handle 12 by means of a conventional drilling or milling machine, which is very easy to manufacture. In addition, the switch member 50 comprises a receptacle 55 for receiving a positioning means 200 comprising a spring 201 and a ball 202. The ball 202 is biased by the spring 201 to be selectively engaged in a respective positioning recess 151, 152 according to the ratcheting direction of the wrench. More particularly, the switch member 50 can be reliably retained in place during ratcheting operation by means of provision of the positioning recesses 151 and 152 and the positioning means 200.

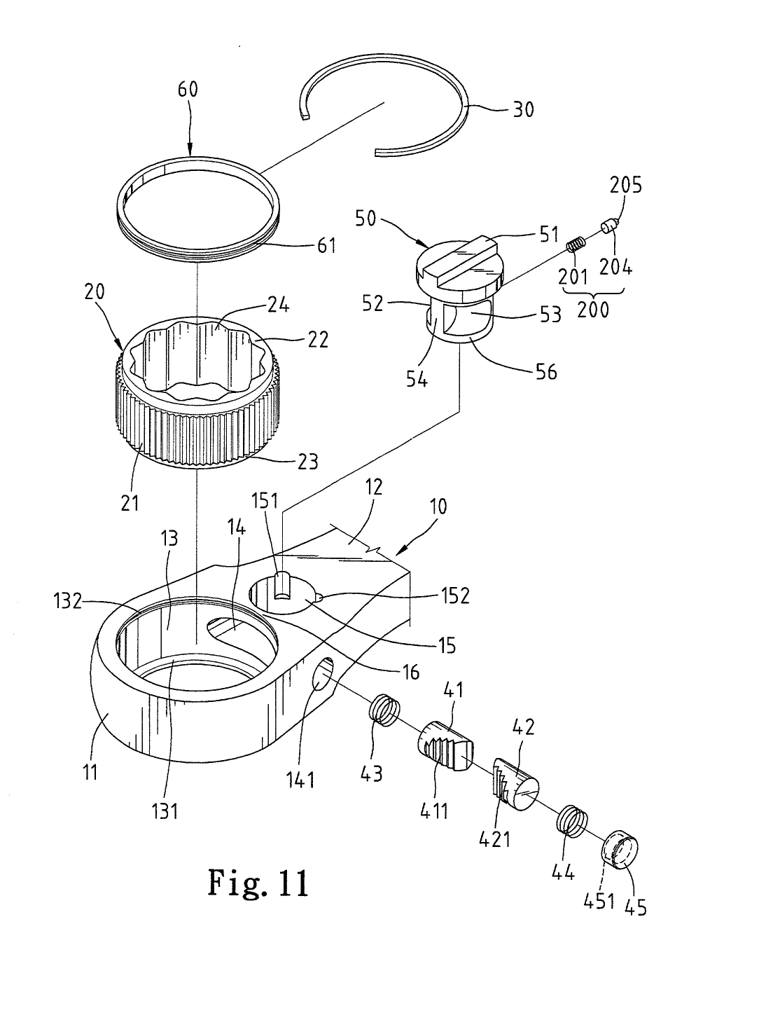

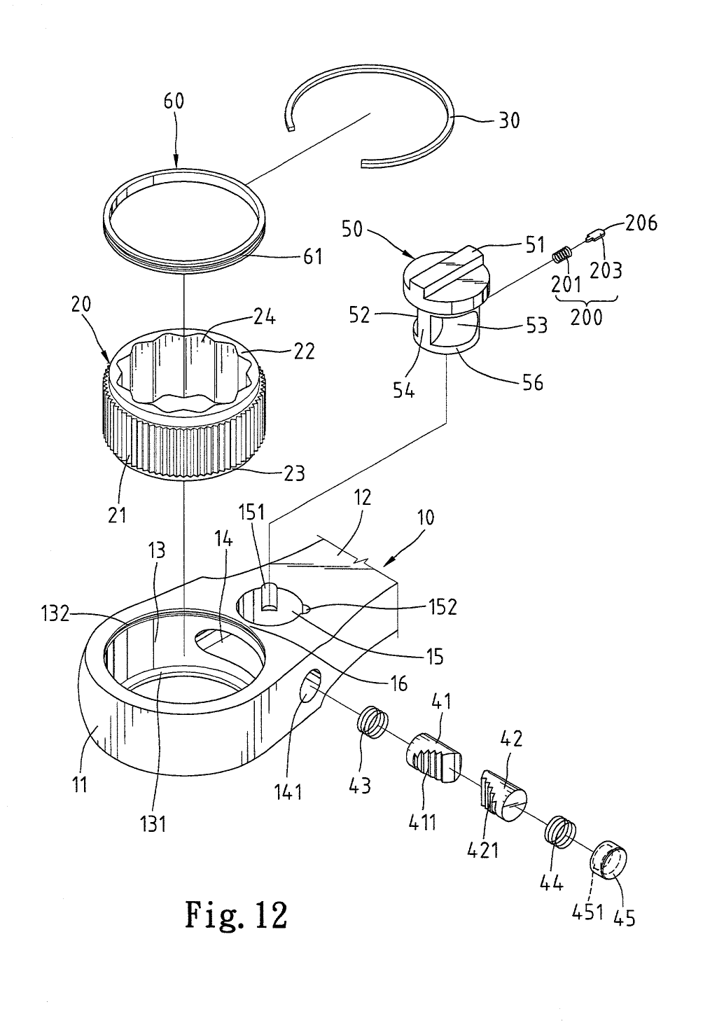

FIG. 11 is an exploded perspective of a further modified embodiment that is modified from the embodiment shown in FIGS. 7 through 10. In this embodiment, the ball is replaced by a pin 204 having a dome 205. FIG. 12 is an exploded perspective of still another modified embodiment that is modified from the embodiment shown in FIGS. 7 through 10. In this embodiment, the ball is replaced by a sheet-like positioning member 204 having an arcuate end 206.

According to the above description, it is appreciated that the torque-bearing capacity of the wrench in accordance with the present invention is greater than conventional designs. In addition, the wrench in accordance with the present invention can be assembled easily. It is noted that the switch member 50 can be assembled without the need of any C-clip or other fasteners. Disengagement of the switch member 50 is prevented by provision of the bottom 56 of the switch member 50 that is located below the pawls 41 and 42. Further, the positioning notches 51 and 52 of the cavity 15 can be formed by means of punching along a vertical direction and then trimming the burs, which is much simpler than formation of an angled-cavity in conventional designs.

Although the invention has been explained in relation to its preferred embodiment, it is to be understood that many other possible modifications and variations can be made without departing from the spirit and scope of the invention as hereinafter claimed.

What is claimed is:

1. A reversible ratchet type wrench comprising:
a handle;
a head extended from the handle and including a hole, the handle comprising a transverse receptacle communicated with the hole, the transverse receptacle comprising an inner longitudinal wall that faces the hole of the head, the handle further comprising a cavity that communicates with the transverse receptacle;
a drive member rotatably mounted in the hole of the head, the drive member including a plurality of teeth formed on an outer periphery thereof,
two pawls mounted in the transverse receptacle in a spaced manner and each including a first side with a plurality of teeth for releasably engaging with the teeth of the drive member and a second side abutting against the inner longitudinal wall of the transverse receptacle;
a switch member including a turn-piece for manual operation, the switch member being rotatably mounted in the cavity of the handle and comprising an actuating portion for selectively moving one of the pawls to a position not engaging with the teeth of the drive member, the switch member further comprising two support portions for selectively supporting a portion of the other pawl that disengages from the inner longitudinal wall of the transverse receptacle, thereby supporting the other pawl that engages with the teeth of the drive member; and
means for biasing the teeth of the pawls to engage with the teeth of the drive member, respectively.

2. The reversible ratchet type wrench as claimed in claim 1, wherein the cavity of the handle extends from a first side of the handle toward a second side of the handle but spaced from the second side of the handle, thereby defining a bridge in the first side of the handle for connection with the head.

3. The reversible ratchet type wrench as claimed in claim 1, wherein the outer periphery of the drive member comprises a first recessed end portion and a second recessed end portion, an inner periphery defining the hole of the head comprising an annular groove in a first end thereof and an annular ledge in a second end thereof, further comprising a retainer mounted in the first end of the head and having a second annular groove, a C-clip being received in the first annular groove of the head and the second annular groove of the retainer, the second recessed portion of the drive member abutting against and being thus supported by the annular ledge of the head.

4. The reversible ratchet type wrench as claimed in claim 1, wherein the biasing means comprises a first elastic element and a second elastic element, further comprising an end cap for enclosing the transverse receptacle, the first elastic element being mounted in the transverse receptacle and having a first end attached to an end wall defining the transverse receptacle and a second end attached to the respective pawl, the second elastic element being mounted in the transverse receptacle and having a first end attached to the end cap and a second end attached to the respective pawl.

5. The reversible ratchet type wrench as claimed in claim 1, wherein the teeth of the respective pawl are arranged along a concave face for intimate contact with the teeth of the drive member.

6. The reversible ratchet type wrench as claimed in claim 1, wherein the drive member is a gear wheel including an inner periphery adapted to drive a fastener.

7. The reversible ratchet type wrench as claimed in claim 1, wherein the drive member includes a drive column for releasably engaging with a socket.

8. The reversible ratchet-type wrench as claimed in claim 1, wherein the switch member comprises a receptacle, the cavity of the handle further comprising a first positioning recess and a second positioning recess, further comprising a positioning means mounted in the receptacle and having a positioning member releasably engaged in one of the first positioning recess and the second positioning recess according to a ratcheting direction of the reversible ratchet type wrench.

9. The reversible ratchet type wrench as claimed in claim 8, wherein the positioning means comprises an elastic element mounted in the receptacle of the switch member and a ball partially received in one of the first positioning recess and the second positioning recess.

10. The reversible ratchet type wrench as claimed in claim 8, wherein the positioning means comprises an elastic element mounted in the receptacle of the switch member and a pin with a dome releasably received in one of the first positioning recess and the second positioning recess.

11. The reversible ratchet type wrench as claimed in claim 8, wherein the positioning means comprises an elastic element mounted in the receptacle of the switch member and a positioning member with an arcuate end releasably received in one of the first positioning recess and the second positioning recess.

12. The reversible ratchet type wrench as claimed in claim 2, wherein the outer periphery of the drive member comprises a first recessed end portion and a second recessed end portion, an inner periphery defining the hole of the head comprising an annular groove in a first end thereof and an annular ledge in a second end thereof, further comprising a retainer mounted in the first end of the head and having a second annular groove, a C-clip being received in the first annular groove of the head and the second annular groove of the retainer, the second recessed portion of the drive member abutting against and being thus supported by the annular ledge of the head.

13. The reversible ratchet type wrench as claimed in claim 2, wherein the biasing means comprises a first elastic element and a second elastic element, further comprising an end cap for enclosing the transverse receptacle, the first elastic element being mounted in the transverse receptacle and having a first end attached to an end wall defining the transverse receptacle and a second end attached to the respective pawl, the second elastic element being mounted in the transverse receptacle and having a first end attached to the end cap and a second end attached to the respective pawl.

14. The reversible ratchet type wrench as claimed in claim 2, wherein the teeth of the respective pawl are arranged along a concave face for intimate contact with the teeth of the drive member.

15. The reversible ratchet type wrench as claimed in claim 2, wherein the drive member is a gear wheel including an inner periphery adapted to drive a fastener.

16. The reversible ratchet type wrench as claimed in claim 2, wherein the drive member includes a drive column for releasably engaging with a socket.

17. The reversible ratchet-type wrench as claimed in claim 2, wherein the switch member comprises a receptacle, the cavity of the handle further comprising a first positioning recess and a second positioning recess, further comprising a positioning means mounted in the receptacle and having a positioning member releasably engaged in one of the first positioning recess and the second positioning recess according to a ratcheting direction of the reversible ratchet type wrench.

18. The reversible ratchet type wrench as claimed in claim 17, wherein the positioning means comprises an elastic element mounted in the receptacle of the switch member and a ball partially received in one of the first positioning recess and the second positioning recess.

19. The reversible ratchet type wrench as claimed in claim 17, wherein the positioning means comprises an elastic element mounted in the receptacle of the switch member and a pin with a dome releasably received in one of the first positioning recess and the second positioning recess.

20. The reversible ratchet type wrench as claimed in claim 17, wherein the positioning means comprises an elastic element mounted in the receptacle of the switch member and a positioning member with an arcuate end releasably received in one of the first positioning recess and the second positioning recess.
